(19) United States
(12) Patent Application Publication
(10) Pub. No.: US 2009/0066294 A1
(43) Pub. Date: Mar. 12, 2009

(54) Dynamic power recharge management for a handheld measurement system

(76) Inventor: Steve Sabram, (US)

Correspondence Address: Philip Thomas Virga, 1525 Aviation Blvd. #105, Redondo Beach, CA, 90278, US

(21) Appl. No.: 12/283,385

(22) Filed: Sep. 10, 2008

Related U.S. Application Data
(60) Provisional application No. 60/993,318, filed on Sep. 10, 2007.

(51) Int. Cl. H02J 7/02; H02J 7/00

(52) U.S. Cl. 320/137

(57) ABSTRACT

The present invention provides a method and system suitable for managing battery power recharging of a handheld measurement system that combines a handheld computer or PDA and a measurement sled. The software consistently monitors both the charge levels of the PDA and sled during recharging by monitoring a difference in recharge needs to give priority to either the handheld computer and/or sled for recharging wherein a recharge need is determined by monitoring a charge level of a corresponding device wherein the charge level is compared to a predetermined threshold level that is set within a sled's microcontroller-based software. Thus, as one of the charge levels passes above its corresponding charge threshold recharge needs may become equal commencing simultaneous recharge at the latter porting of system recharging. This allows for the low charge levels to be exclusively recharged from the external power source at the beginning of the recharge cycle making for a time efficient recharge cycle.

### CROSS-REFERENCE TO PROVISIONAL APPLICATION

Attention is directed to provisional application No. 60/993,318, filed Sep. 10, 2007, entitled “Dynamic Power Recharge Management of a Dually Rechargeable PDA,” Attorney Docket No. S/S1021. The disclosure of this provisional application is hereby incorporated by reference in its entirety.

### BACKGROUND

1. Field of the Invention

The present invention relates generally to handheld measurement devices and, in particular, to the battery power recharge management of handheld power devices.

2. Background

A typical handheld measurement system consists of software and simple hardware attachments for a given smartphone or handheld computer or PDA (personal digital assistant), such as a Palm handheld computer. Sensors are attached to the hardware attachment, turning the handheld computer into a state-of-the-art, handheld test and measurement instrument. By using a smartphone or PDA or handheld computer as a measurement device, there is an increase in the amount of time the handheld is in use. This places an ever-increasing demand on the amount of time the handheld devices are able to provide functionality between rechargings.

Currently the most effective way of conserving power and thereby extending the amount of time a handheld measurement device may be used, is simply turning the device off.

Consequently, a need exists for a dynamic power recharge management system on handheld measurement devices that enhances the power availability of the device by dually recharging the client machine or PDA and its measurement attachment.

### SUMMARY

The present invention provides a method and system suitable for managing battery power recharging of a handheld measurement system that combines a handheld computer or PDA and a measurement sled. The software consistently monitors both the charge levels of the PDA and sled during recharging by monitoring a difference in recharge needs to give priority to either the handheld computer and/or sled for recharging wherein a recharge need is determined by monitoring a charge level of a corresponding device wherein the charge level is compared to a predetermined threshold level that is set within a sled's microcontroller-based software. Thus, as one of the charge levels passes above its corresponding charge threshold recharge needs can become equal commencing simultaneous recharge at the latter porting of system recharging. This allows for the low charge levels to be exclusively recharged from the external power source at the beginning of the recharge cycle making for a time efficient recharge cycle.

Other features and advantages will be apparent to one skilled in the art given the benefit of the following disclosure.

### BRIEF DESCRIPTION OF THE DRAWINGS

Other objects, features, and advantages of the present invention will be apparent from the written description and the drawings in which:

FIG. 1 illustrates a system block diagram for dynamic recharging of both a handheld computer and measurement sled;

FIG. 2 illustrates the connection of the handheld computer to the measurement sled of FIG. 1 and different power recharging means for the handheld computer and sled;

FIG. 3 illustrates a system level block diagram of the internal components that manage recharging of the handheld measurement system;

FIG. 4 is a flowchart illustrating monitoring the power level within a handheld computer or PDA; and

FIG. 5 is a flowchart illustrating one embodiment of a method for power recharge management utilized within the measurement sled in association with the power recharge management routine used by the handheld computer or smartphone or personal digital assistant.

### DETAILED DESCRIPTION

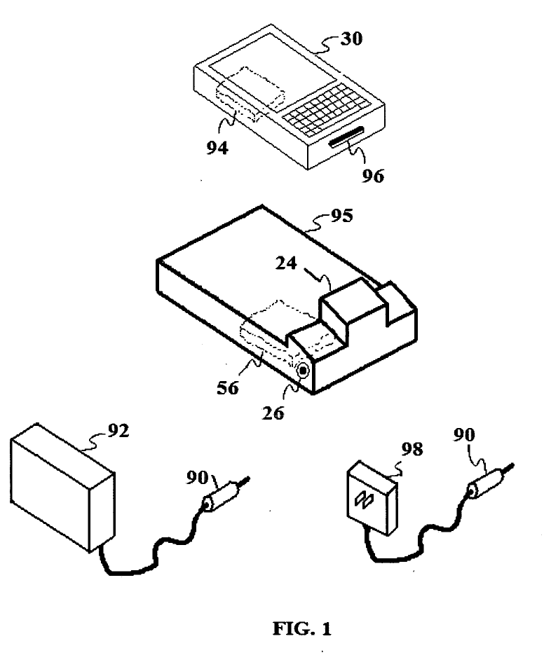

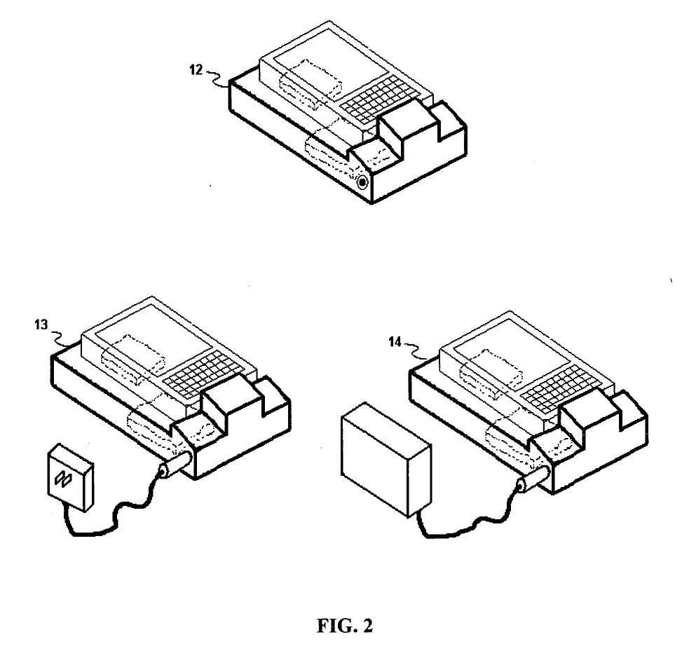

Referring now to FIGS. 1 and 2 there are shown block diagrams for a system for dynamically recharging the batteries of both a rechargeable handheld computer such as a Personal Digital Assistant (henceforth known as a “PDA”) and an external attachment to said PDA that is also rechargeable (henceforth know as a “Sled”.) The system is based on the initial battery charge level of both the PDA and the Sled which are taken into consideration in managing recharging of both devices to optimize full system recharge.

Turning to FIG. 1 there is shown a commercial PDA 30 that has an internal rechargeable battery 94 and a docking port 96 that can handle external power to recharge the PDA battery 94 and receive serial communications from external devices. The external device that attaches to the PDA 30 is in the form of a Measurement Sled 95 that also has an internal rechargeable battery 56 and a port 24 which mates with PDA 30. This sled has an external power port 26 that takes in regulated power by either an external, large capacity rechargeable battery 92 with a matching power plug 90. The sled 95 can also be powered via a power adaptor 98 that converts power from a stationary AC power outlet into power that the sled can take via the power converter plug 90.

The items mentioned above can be configured in various means as shown in FIG. 2. The intention is for the portable system of PDA 30 and Sled 95 to be mechanically and electrically connected 12 to be recharged in two different manners. One is in a configuration with the above mentioned power adaptor connected 13 and the other is the system to be recharged with the above mentioned external battery connected 14.

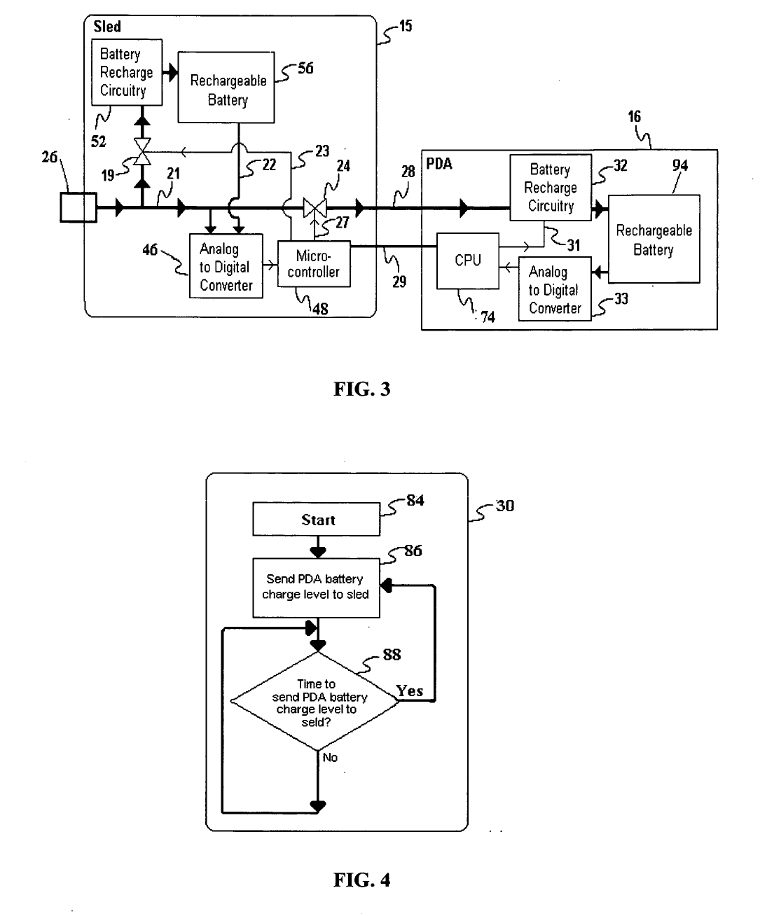

Turning now to FIG. 3 there is shown a system level block diagram of the internal components that manage recharging of the handheld measurement system. The sled 15 has its external power connector 26 connected to the internal initial recharging power path 21 where its connectivity is controlled by two power gates 19 and 24 respectively. One power gate 19 controls external power access to the sled's battery recharge circuitry 52 for charging the sled's internal rechargeable battery 56. The other power gate 24 controls access to the smartphone or PDA recharge line 28. Both of these power gates are controlled by the sleds microcontroller 48 that drives two digital lines for recharge control. One of these digital lines 23 controls the power gate to the sleds battery and the other digital line 27 controls the power gate to the smartphone or PDA. The charge level is monitored in the form of the sled's battery voltage level 22 by connecting it to an analog to digital converter 46 that is in turn connected to the microcontroller.

The sled's microcontroller 48 stores both the sled's charge level and the smartphone or PDA charge level. The smartphone or PDA charge level is initiated by software 16 running in the smartphone or PDA that has its own rechargeable battery 94. This is performed from software running on the smartphone or PDA's central processing unit 74 running the smartphone or PDA's battery recharge circuitry 32 and an analog to digital converter 33 via internal digital communications line 31. This smartphone or PDA charge level is sent to the sled via a serial communications line 29 that is being monitored by the sled's microcontroller.

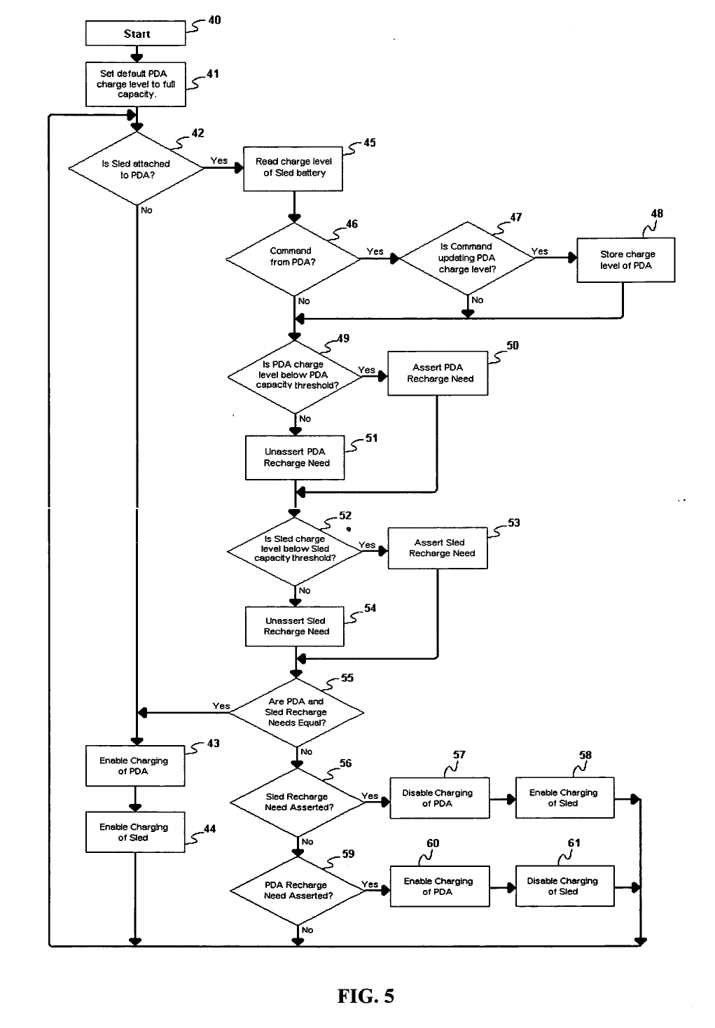

FIG. 4 is a flowchart illustrating one embodiment of a method for power recharge management routine utilized in the smartphone or personal digital assistant wherein the software monitoring the smartphone or PDA charge level is minimal. This software runs inside the smartphone or PDA 30. At the start of the monitoring software 84 the smartphone or PDA charge level is immediately sent to the sled 86. Then, the software waits for a specific period of time to pass 88 to send the smartphone or PDA charge level to the sled again.

FIG. 5 is a flowchart illustrating one embodiment of a method for power recharge management utilized within the measurement sled in association with the power recharge management routine used by the smartphone or personal digital assistant. The software running in the microcontroller of the sled 39 performs the power recharge management of both the sled and the smartphone or PDA. At the start of the sled's power management software 40 a default value charge capacity level of 100% is assigned 41 before any actual charge level is sent from the smartphone or PDA.

Since there is the possibility that the smartphone or PDA may be detached from the sled, the connection status of the smartphone or PDA is monitored 42. If there is not a smartphone or PDA attached, the power access gate for recharging the sled is enabled 43 and so is the recharging of the smartphone or PDA 44. Both are turned on to optimize recharge speed of both devices when the smartphone or PDA is suddenly attached. If the smartphone or PDA is attached, the software reads the sled's charge level 45 and waits for a command from the PDA 46 and then checks if it is a command describing the PDA's charge level 47. The command is parsed and the PDA charge level is stored 48 for the whole system charge level.

With the software now storing both the charge level of the smartphone or PDA and the sled, two Boolean states called Recharge Need can be determined. If the Recharge Need is asserted, then the corresponding device needs recharging power sent to it. The two Recharge Needs in this system are smartphone or PDA Recharge Need and Sled Recharge Need. The goal of this software is to monitor difference in Recharge Needs to give priority to either the smartphone or PDA and/or sled for recharging. A Recharge Need is determined by monitoring the charge level of the corresponding device. This charge level is compared to a predetermined Threshold Level that is set within the Sled's microcontroller-based software. The first comparison is to determine the smartphone or PDA charge level is below its corresponding Threshold Level 49. If the smartphone or PDA charge level is below the smartphone or PDA Threshold level, the PDA Recharge Need is asserted 50 else the smartphone or PDA Recharge Need is unasserted 51. Then the Sled charge level is compared with the Sled Threshold level 52. If the Sled Threshold is below the Sled charge level, the Sled Recharge need is asserted 53 else, it is unasserted 54.

Now the two Recharge Needs may be compared. If the recharge needs are equal 55 then there is no priority given to recharging and both power gates are enabled. However, if they are different, priorities are assigned. First the Sled Recharge Need is asserted 56 the charging of the PDA is disabled 57 and the charging of the sled is enabled 58. Henceforth, if the PDA Recharge Need is asserted 59 then the charging of the PDA is enabled 60 and the charging of the sled is disabled 61.

In summary, the software consistently monitors both the charge levels of the PDA and sled during recharging. Thus, as one of the charge levels passes above its corresponding charge threshold, Recharge Needs can become equal commencing simultaneous recharge at the latter porting of system recharging. This allows for the low charge levels to be exclusively recharged from the external power source at the beginning of the recharge cycle making for a time efficient recharge cycle.

The scope of the invention is, therefore, indicated by the appended claims, rather than by the foregoing description. All changes which come within the meaning and range of equivalency of the claims are to be embraced within their scope.

What is claimed is:

1. A method for dynamic power recharging management for a handheld measurement system having a handheld computer and measurement sled comprising:
monitoring a difference in recharge needs to give priority to either the handheld computer and/or the sled for recharging wherein a recharge need is determined by monitoring a charge level of a corresponding device wherein said charge level is compared to a predetermined threshold level that is set within a sled's microcontroller-based software.

2. The method for dynamic power recharging management for a handheld measurement system in accordance with claim 1 in which by setting a default value charge capacity level of 100 percent before a charge level is sent from the handheld computer.

3. The method for dynamic power recharging management for a handheld measurement system in accordance with claim 2 by monitoring a connection status of the handheld computer wherein if the handheld computer and sled are not attached a power access gate for recharging the sled is enabled in addition to recharging of the handheld computer wherein both are turned on to optimize recharge speed of both devices when both are suddenly attached.

4. The method for dynamic power recharging management for a handheld measurement system in accordance with claim 3 wherein when the handheld computer and the sled are attached the sled's charge level is read and waits for a command from the handheld computer and then checks if it is a command describing the handheld computer charge level wherein said command is parsed and the handheld computer's charge level is stored as a whole system charge level.

5. The method for dynamic power recharging management for a handheld measurement system in accordance with claim 4 by storing both the charge level of the handheld computer and the sled thereby creating two Boolean states called recharge need may be determined wherein if a Recharge Need is asserted, then the corresponding device needs recharging power sent to it.

6. The method for dynamic power recharging management for a handheld measurement system in accordance with claim 5 by monitoring difference in recharge needs a priority is given to either the handheld computer and/or the sled for recharging wherein said charge level is compared to a predetermined threshold level that is set within the sled's microcontroller-based software.

7. The method for dynamic power recharging management for a handheld measurement system in accordance with claim 6 by determining if a charge level of the handheld computer is below its corresponding threshold level a handheld computer recharge need is asserted else said handheld computer recharge need is unasserted.

8. The method for dynamic power recharging management for a handheld measurement system in accordance with claim 7 wherein said sled charge level is compared with the sled threshold level wherein if said sled threshold is below the sled charge level the sled recharge need is asserted else, it is unasserted.

9. The method for dynamic power recharging management for a handheld measurement system in accordance with claim 8 wherein the two recharge needs are compared and if said recharge needs are equal then there is no priority give to recharging and both power gates are enabled.

10. The method for dynamic power recharging management for a handheld measurement system in accordance with claim 9 wherein if recharge needs are different said sled recharge need is asserted and the charging of the handheld computer is disabled and the charging of the sled is enabled.

11. The method for dynamic power recharging management for a handheld measurement system in accordance with claim 10 wherein the handheld computer recharge need is asserted then charging of the handheld computer is enabled and the charging of the sled is disabled.

12. A method for managing battery power recharging of a handheld measurement system that combines a handheld computer or PDA and a measurement sled, comprising:
consistently monitoring both the charge levels of the PDA and the sled during recharging by monitoring a difference in recharge needs to give priority to either the handheld computer and/or the sled for recharging wherein said recharge needs is determined by monitoring a charge level of a corresponding device wherein said charge level is compared to a predetermined threshold level that is set within a sled's microcontroller-based software and as one of said charge levels passes above its corresponding charge threshold, recharge needs may become equal commencing simultaneous recharge at a latter porting of system recharging thereby allowing for low charge levels to be exclusively recharged from an external power source at a beginning of a recharge cycle making for a time efficient recharge cycle.
